(19) United States
(12) Patent Application Publication
(10) Pub. No.: US 2026/0019205 A1
(43) Pub. Date: Jan. 15, 2026

(54) ASSOCIATIONS BETWEEN ANTENNA PORTS AND PORT GROUPS

(71) Applicant: ZTE Corporation, Shenzhen (CN)

(72) Inventors: Meng MEI, Shenzhen (CN); Bo GAO, Shenzhen (CN); Yang ZHANG, Shenzhen (CN); Ke YAO, Shenzhen (CN); Xiaolong GUO, Shenzhen (CN)

(21) Appl. No.: 19/334,555

(22) Filed: Sep. 19, 2025

Related U.S. Application Data
(63) Continuation of application No. PCT/CN2023/087115, filed on Apr. 7, 2023.

(51) Int. Cl. H04L 5/00; H04L 1/00

(52) U.S. Cl. CPC H04L 5/0044; H04L 1/0003; H04L 5/0051

(57) ABSTRACT

Methods, apparatus, and systems that relate to associations of antenna ports and port groups for various types of reference signals are disclosed to help reduce transmission loss and enable effective communications between the base station and user equipment (UE). In one example aspect, a method for wireless communication includes configuring, by the base station, one or more phase-tracking reference signal (PTRS) ports that are associated with antenna ports in a number of antenna port groups. One or more antenna ports in an antenna port group share a same PTRS port. The method also includes performing, by the base station, the uplink transmission with a terminal device based on the one or more PTRS ports.

### TECHNICAL FIELD

This patent document is directed to digital communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques that related to the associations of antenna ports and port groups for various types of reference signals to reduce transmission loss and enable effective communications between the base station and user equipment (UE).

In one example aspect, a method for wireless communication includes configuring, by the base station, one or more phase-tracking reference signal (PTRS) ports that are associated with one or more antenna ports in a number of antenna port groups. One or more antenna ports in an antenna port group share a same PTRS port. The method also includes performing, by the base station, the uplink transmission with a terminal device based on the one or more PTRS ports.

In one example aspect, a method for wireless communication includes determining, by a terminal device for an uplink transmission, one or more phase-tracking reference signal (PTRS) ports that are associated with one or more antenna ports in a number of antenna port groups. One or more antenna ports in an antenna port group share a same PTRS port, and performing, by the terminal device, the uplink transmission with a base station based on the one or more PTRS ports.

In another example aspect, a communication apparatus is disclosed. The apparatus includes a processor that is configured to implement an above-described method.

In yet another example aspect, a computer-program storage medium is disclosed. The computer-program storage medium includes code stored thereon. The code, when executed by a processor, causes the processor to implement a described method.

These, and other, aspects are described in the present document.

### BRIEF DESCRIPTION OF DRAWINGS

FIG. 1A illustrates a method for wireless communication in accordance with one or more embodiments of the present technology.

FIG. 1B illustrates a method for wireless communication in accordance with one or more embodiments of the present technology.

FIG. 2A illustrates an example of organizing antenna ports into two antenna port groups in accordance with one or more embodiments of the present technology.

FIG. 2B illustrates another example of organizing antenna ports into two antenna port groups in accordance with one or more embodiments of the present technology.

FIG. 2C illustrates yet another example of organizing antenna ports into two antenna port groups in accordance with one or more embodiments of the present technology.

FIG. 3A illustrates an example of organizing antenna ports into four antenna port groups in accordance with one or more embodiments of the present technology.

FIG. 3B illustrates another example of organizing antenna ports into four antenna port groups in accordance with one or more embodiments of the present technology.

FIG. 3C illustrates yet another example of organizing antenna ports into four antenna port groups in accordance with one or more embodiments of the present technology.

FIG. 4 shows an example of a wireless communication system where techniques in accordance with one or more embodiments of the present technology can be applied.

FIG. 5 is a block diagram representation of a portion of a radio station in accordance with one or more embodiments of the present technology can be applied.

### DETAILED DESCRIPTION

Section headings are used in the present document only to improve readability and do not limit scope of the disclosed embodiments and techniques in each section to only that section. Furthermore, some embodiments are described with reference to Third Generation Partnership Project (3GPP) Fifth Generation (5G) New Radio (NR) or Sixth Generation (6G) standard for case of understanding and the described technology may be implemented in different wireless system that implement protocols other than the NR or 6G protocol.

In wireless communications, many reference signals are used to for different purposes to enable more accurate and efficient transmissions of information. For example, the Sounding Reference Signal (SRS) is a kind of reference signal transmitted from the User Equipment (UE) to the base station so that the base station can perform channel quality estimation for uplink. The Demodulation Reference Signal (DMRS) is a reference signal used for decoding data transmissions in both the downlink and uplink directions. The Phase Tracking Reference Signal (PTRS) is used for tracking the phase of the local oscillator at the receiver and transmitter, thereby enabling suppression of phase noise and common phase error, which is particularly important at high carrier frequencies such as millimeter wave. Other reference signals, such as the Channel State Information (CSI) Reference Signal (RS), provide mechanisms for providing measurements and measurement reporting for channel state estimation.

In the current NR design, up to four DMRS ports are supported, up to four SRS ports are supported, and up to two PTRS ports are supported for one UE. With the advancement of wireless communication technology, more than four SRS ports and more than four DMRS ports can be supported for a UE in the uplink direction. The number of supported PTRS ports can also increase. Give the increasing number of ports for various types of reference signals, there remains a need to define the association between different ports for reference signal designs for the improvement of communications.

This patent document discloses techniques that can be implemented in various embodiments to enable proper association between the reference signal antenna ports (e.g., SRS ports and PTRS ports, the DMRS ports and the PTRS ports). When the number of antenna ports increases, the antenna ports are considered to be in groups based on characteristics such as the UE's support for full/partial coherent transmissions and/or the modulation and coding schemes. For example, if there are eight antenna ports and full coherent codebook is supported, the antenna ports can be considered as one antenna port group. If partial coherent codebook is supported, the antenna ports can be considered as being categorized into two or four antenna port groups. If non-coherent codebook or non-codebook transmission is supported, each port is considered as a group. The antenna port group(s) are associated with one or more PTRS ports to reduce transmission errors. For example, when full coherent codebooks are supported, up to one PTRS port is supported. For partial/non-coherent codebook-based transmissions or non-codebook-based transmissions, the max number of PTRS ports is configured by the base station. The actual number of PTRS is based on additional factors, such as the rank value. When the indicated rank is less than 4, only one PTRS ports may be needed. When the indicated MCS of one codeword is less than the configured MCS threshold, one or zero PTRS port may be needed. When the indicated DMRS port is associated with one antenna port group, one PTRS port may be needed.

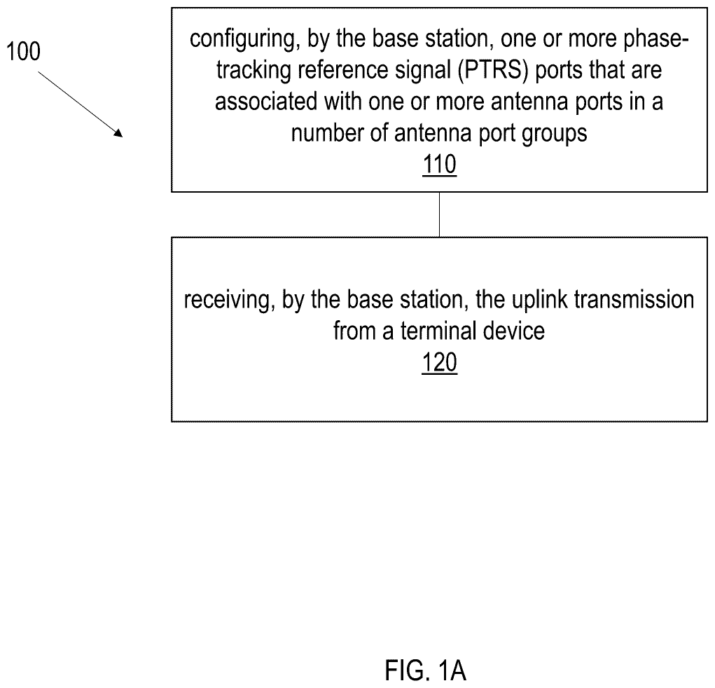

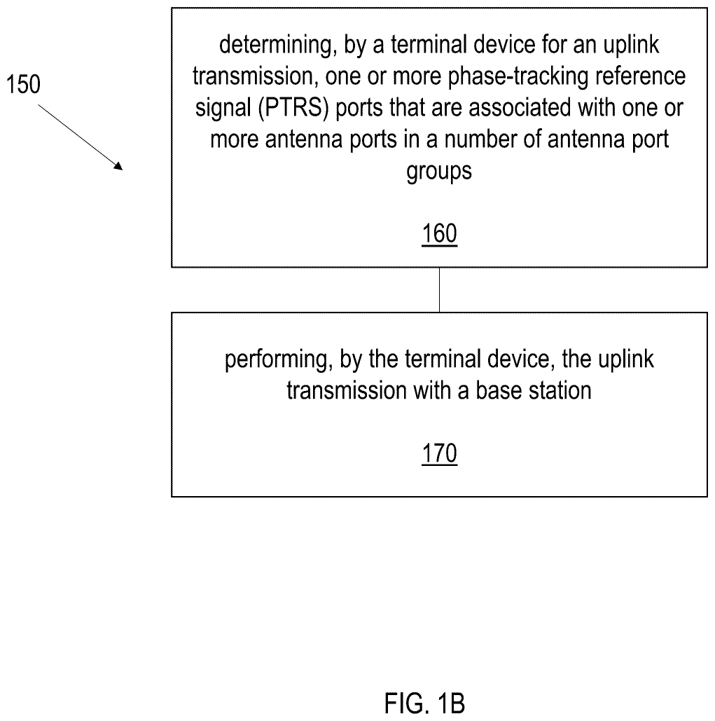

FIG. 1A illustrates a method for wireless communication in accordance with one or more embodiments of the present technology. The method 100 includes, at operation 110, configuring, by a base station, one or more phase-tracking reference signal (PTRS) ports that are associated with one or more antenna ports in a number of antenna port groups. One or more antenna ports in an antenna port group share a same PTRS port. The method 100 also includes, at operation 130, receiving, by the base station, an uplink transmission with a terminal device based on the one or more PTRS ports.

FIG. 1B illustrates a method for wireless communication in accordance with one or more embodiments of the present technology. The method 150 includes, at operation 160, determining, by a terminal device for an uplink transmission, one or more phase-tracking reference signal (PTRS) ports that are associated with one or more antenna ports in a number of antenna port groups. One or more antenna ports in an antenna port group share a same PTRS port. The method 150 includes, at operation 170, performing, by the terminal device, the uplink transmission with a base station based on the one or more PTRS ports.

In some embodiments, the antenna ports comprise Demodulation Reference Signal (DMRS) ports or Sounding Reference Signal (SRS) ports. In some embodiments, the antenna ports are organized based on a capability of a terminal device (e.g., full/partial coherent or non-codebook-based transmission) or an indication/configuration of the base station (e.g., Modulation and Coding Scheme, MCS, values). How the antenna ports are considered to be in one or more groups can also be pre-defined (e.g., predefined in the 3GPP standard or as a pre-defined configuration).

In some embodiments, a capability of the terminal device indicates whether the terminal device supports coherent transmissions, and the antenna ports are in more than one antenna port groups in response to the terminal device supporting partial coherent transmissions, non-coherent transmissions, or non-codebook-based transmissions. In some embodiments, the antenna ports are in one antenna port group corresponding to one PTRS port. In some embodiments, the antenna ports are in two antenna port groups corresponding to two PTRS ports. In some embodiments, the two antenna port groups comprise at least one of: a first group of ports {0, 1, 2, 3} and a second group of ports {4, 5, 6, 7}; a first group of ports {0, 1, 4, 5} and a second group of ports {2, 3, 6, 7}; or a first group of ports {0, 2, 4, 6} and a second group of ports {1, 3, 5, 7}. In some embodiments, the antenna ports are in four antenna port groups corresponding to two PTRS ports/antenna ports in a first antenna port group and a second antenna port group share a first PTRS port, and antenna ports in a third antenna port group and a fourth antenna port group share a second PTRS port. In some embodiments, the antenna ports are in four antenna port groups corresponding to four PTRS ports. In some embodiments, the four antenna port groups comprise at least one of: a first group of ports {0, 2}, a second group of ports {1, 3}, a third group of ports {4, 6}, and a fourth group of ports {5, 7}; or a first group of ports {0, 1}, a second group of ports {2, 3}, a third group of ports {4, 5}, and a fourth group of ports {6, 7}.

In some embodiments, a single PTRS port is configured, and a 3-bit indication is used to indicate an association of the single PTRS port to a DMRS port in response to at least one of: the number of antenna port groups being configured as 2 or 4 or 8, or the uplink transmission being a partial coherent codebook-based transmission, a non-coherent codebook-based transmission, or a non-codebook-based transmission.

In some embodiments, a modulation and coding scheme (MCS) configured by the base station is associated with the one or more PTRS port. In some embodiments, a PTRS port is associated with an antenna port group corresponding to a higher modulation and coding scheme (MCS) than other one or more antenna port groups. In some embodiments, a PTRS port is associated with an antenna port corresponding to a higher modulation and coding scheme (MCS) than other antenna ports in an antenna port group.

In some embodiments, an actual number of PTRS ports used for the uplink transmission is based on at least one of: an indicated rank number, a transmitted precoding matrix indicator (TPMI), an SRS resource indicator (SRI), a number of codewords, or an MCS of a codeword. In some embodiments, a PTRS port is absent in response to codewords having MCS values lower than a single MCS threshold that is reported by the terminal device or configured or indicating by based station. In some embodiments, a PTRS port is absent in response to a MCS value of a codeword being lower than a corresponding MCS threshold, where two MCS thresholds are reported by the terminal device or configured or indicated by based station corresponding to two codewords.

In some embodiments, a time domain density of PTRS ports used for the uplink transmission is based on an indicated MCS I_{MCS1} or I_{MCS2} for a codeword compared with the configured or reported MCS threshold as shown in Table 1 and Table 2 below. Some MCS thresholds are configured or reported corresponding to different time domain densities, e.g., 4, 2 and 1.

TABLE 1
Example PTRS for codeword 1

| Scheduled MCS | Time density (L_{PT-RS}) |
|---|---|
| I_{MCS1} < ptrs-MCS₁ | PT-RS is not present |
| ptrs-MCS1 ≤ I_{MCS1} < ptrs- | 4 |
| MCS2 | |
| ptrs-MCS2 ≤ I_{MCS1} < ptrs- | 2 |
| MCS3 | |
| ptrs-MCS3 ≤ I_{MCS1} < ptrs- | 1 |
| MCS4 | |

TABLE 2
Example PTRS for codeword 2

| Scheduled MCS | Time density (L_{PT-RS}) |
|---|---|
| I_{MCS2} < ptrs-MCS₁ | PT-RS is not present |
| ptrs-MCS1 ≤ I_{MCS2} < ptrs- | 4 |
| MCS2 | |
| ptrs-MCS2 ≤ I_{MCS2} < ptrs- | 2 |
| MCS3 | |
| ptrs-MCS3 ≤ I_{MCS2} < ptrs- | 1 |
| MCS4 | |

In some embodiments, an association between an antenna port group and a corresponding PTRS port is indicated to the terminal device via a signaling message. In some embodiments, the codeword is associated with one antenna port group. In some embodiments, the signaling message comprises a Radio Resource Control (RRC) signaling or a Downlink Control Information (DCI) signaling.

Further details of the disclosed technology are described in the embodiments below.

### Embodiment 1: Associations Between SRS Ports/Port Groups and PTRS Ports

This embodiment discloses example associations between the SRS ports/port groups and the PTRS ports.

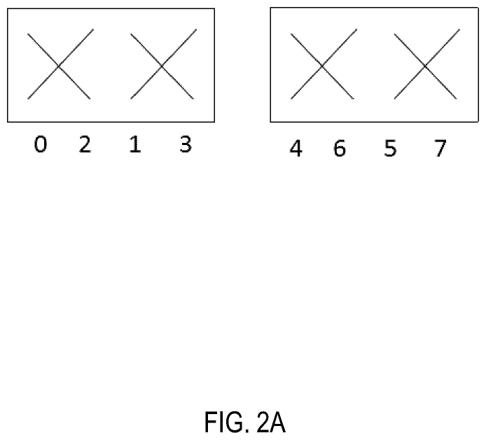

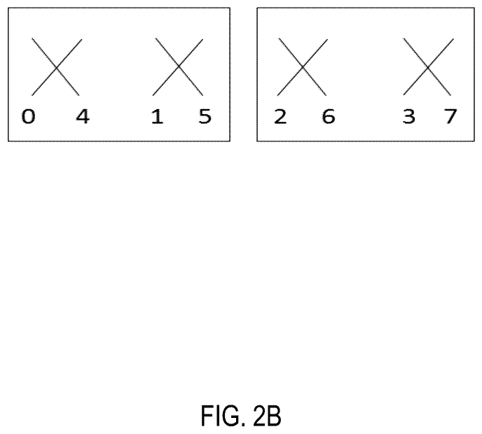

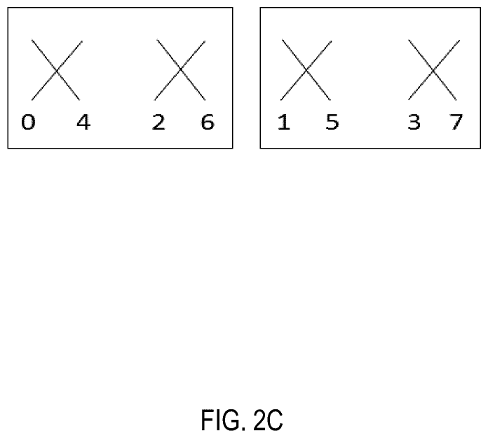

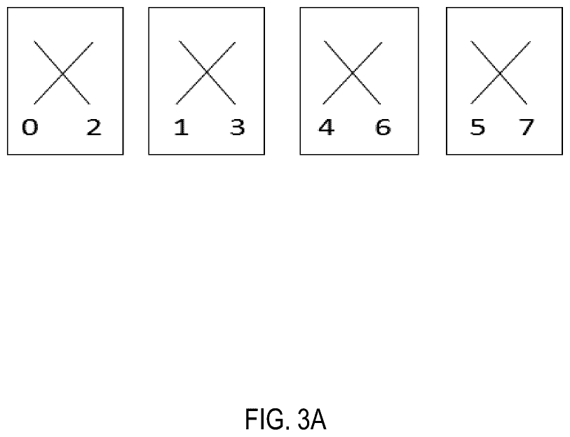

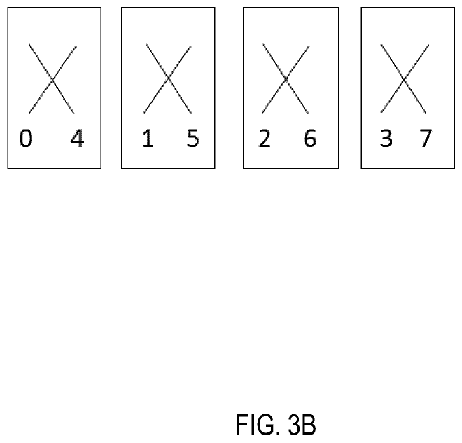

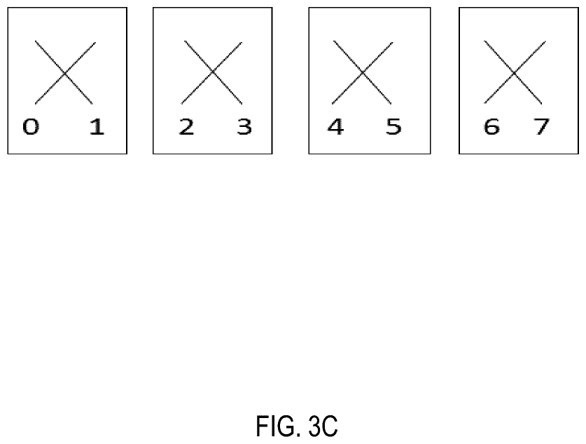

In some embodiments, full coherent codebooks are supported, and the antenna ports are categorized as in only one antenna port group. In those cases, up to one PTRS port is supported. In some embodiments, partial coherent codebooks are supported, the max number of PTRS ports is configured by the base station and the antenna ports are categorized as in multiple antenna groups. For example, when there are eight SRS ports, the eight SRS ports can be in two antenna port groups (e.g., as shown in FIGS. 2A-2C) or four antenna port groups (e.g., as shown in FIGS. 3A-3C).

In some embodiments, if the antenna ports are in two antenna port groups, up to two PTRS ports can be supported. The base station can configure that the max number of PTRS port is 1 or 2. If the antenna ports are in four antenna port groups, up to 2 or 4 PTRS ports can be supported. The base station can configure that the max number of PTRS port is 1 or 2. Alternatively, the base station can configure that the max number of PTRS port is 1, 2, or 4.

In some embodiments, when two codewords are used for the transmission or the max rank is configured or indicated to be greater than 4, and the max number of PTRS ports is configured to be greater than 1, the association of the PTRS and SRS port or antenna port group can be one of the following cases:

Case 1-1: The antenna ports are in two antenna port groups (e.g., two antenna port groups are configured) and each antenna port group is associated with one PTRS port. For example, the first antenna port group is associated with PTRS port 0, and the second antenna port group is associated with PTRS port 1.

FIG. 2A illustrates an example of organizing antenna ports into two antenna port groups in accordance with one or more embodiments of the present technology. In this example, eight SRS ports are in two groups. Ports {0,2, 1,3}/{0,1,2,3} are in the first antenna port group and they share PTRS port 0. Ports {4,6,5,7}/{4,5,6,7} are in the second antenna port group and they share PTRS port 1. In such case, the two antenna port groups are independent, e.g., from physical design perspective, the two antenna port groups are fixed in a relatively large distance.

FIG. 2B illustrates another example of organizing antenna ports into two antenna port groups in accordance with one or more embodiments of the present technology. In this example, eight SRS ports are in two groups. Ports {0,4, 1,5}/{0,1,4,5} are in the first antenna port group, and they share PTRS port 0. Ports {2,6,3,7}/{2,3,6,7} are in the second antenna port group and they share PTRS port 1. In such case, the antenna ports are marked from one polarized direction first and then the other polarized direction.

FIG. 2C illustrates yet another example of organizing antenna ports into two antenna port groups in accordance with one or more embodiments of the present technology. In this example, eight SRS ports are in two port groups. Ports {0,2,4,6}/{0,4,2,6} are in the first antenna port group, and they share PTRS port 0. Ports {1,3,5,7}/{1,5,3,7} are in the second antenna port group, and they share PTRS port 1. In such case, alternating antenna ports are marked based on polarized directions, e.g., antenna port #0 is marked for antenna port group from one polarized direction and antenna port #1 is marked for another antenna port group from the other polarized direction.

Case 1-2: The antenna ports are in four antenna port groups (e.g., four antenna port groups are configured) and each two antenna port groups are associated with one PTRS port. For examples, Groups 1, 2, 3, 4 are configured. Group 1 and Group 2 are associated with PTRS port 0, and Group 3 and Group 4 are associated with PTRS port 1. Alternatively, Group 1 and Group 3 are associated with PTRS port 0, and Group 2 and Group 4 are associated with PTRS port 1. The association between the groups and the PTRS ports can be pre-defined or RRC configuration from the base station.

Case 1-3: The antenna ports are in four antenna port groups (e.g., four antenna port groups are configured) and the max number of PTRS ports is four. Each antenna group is associated with one PTRS port.

FIG. 3A illustrates an example of organizing antenna ports into four antenna port groups in accordance with one or more embodiments of the present technology. In this example, eight SRS ports are in four groups. Ports {0,2} are in the first antenna port group and they share PTRS port 0. Port {1, 3} are in the second antenna port group and they share PTRS port 1. Port {4, 6} are in the third antenna port group and they share PTRS port 2. Port {5, 7} are in the fourth antenna port group and they share PTRS port 3. In such case, the two antenna port groups are independent, e.g., from physical design perspective, the two antenna port groups are fixed in a relatively large distance.

FIG. 3B illustrates an example of organizing antenna ports into four antenna port groups in accordance with one or more embodiments of the present technology. In this example, eight SRS ports are in four groups. Ports {0,4} are in the first antenna port group and they share PTRS port 0. Port {1, 5} are in the second antenna port group and they share PTRS port 1. Port {2, 6} are in the third antenna port group and they share PTRS port 2. Port {3, 7} are in the fourth antenna port group and they share PTRS port 3. In such case, the antenna ports are marked based on polarized directions.

FIG. 3C illustrates yet another example of organizing antenna ports into four antenna port groups in accordance with one or more embodiments of the present technology. In this example, eight SRS ports are in four groups. Ports {0,1} are in the first antenna port group and they share PTRS port 0. Port {2, 3} are in the second antenna port group and they share PTRS port 1. Port {4, 5} are in the third antenna port group and they share PTRS port 2. Port {6, 7} are in the fourth antenna port group and they share PTRS port 3.

In some embodiments, for non-coherent codebook-based uplink transmission and non-codebook-based transmission, eight antenna port are configured or indicated for eight antenna port groups. If a single PTRS port is configured, all the antenna ports share the same PTRS port. If a maximum of two PTRS ports are configured, four of antenna port groups/antenna ports share one PTRS, and the remaining antenna port groups/antenna ports share the other PTRS. If a maximum of four PTRS ports are configured, the antenna port groups/antenna ports are associated with the PTRS ports, such as {0,1}/{2,3}/{4,5}/{6,7} or {0,2}/{1,3}/{4,6}/{5,7} or {0,4}/{1,5}/{2,6}/{3,7}.

### Embodiment 2: Associations Between DMRS Ports/Port Groups and PTRS Ports

This embodiment discloses example associations between the DMRS ports/port groups and the PTRS ports.

In some embodiments, for non-coherent codebook-based uplink transmissions and non-codebook-based transmissions, the maximum number of PTRS ports is configured to be one. In some embodiments, the single PTRS port is associated with DMRS ports that correspond to a codeword of a higher MCS value. In some embodiments, the single PTRS port is shared by all the DMRS ports. An indicator can be used to indicate which DMRS port is associated with the PTRS port. For example, when there are eight DMRS ports, an indicator having 3 bits can be included in the DCI to indicate which DMRS port is associated with the PTRS port.

In some embodiments, more than one PTRS ports can be configured. However, not all configured PTRS ports may be used for the transmissions. The actual number of PTRS ports used for the transmission is associated with the MCS value of each codeword. In some embodiments, the PTRS port(s) can be enabled but the actual number of PTRS ports remains to be 0. For example, only the DMRS port(s) corresponding to the codeword with higher MCS value are associated with PTRS port(s). However, if the MCS value is lower than a MCS threshold that enable PTRS transmission, the actual number of PTRS ports is 0.

In some embodiments, the DMRS ports can be in two antenna port groups based on MCS value(s). A PTRS port can be associated with the group corresponding to the codeword with a higher MCS value. Up to 4 DMRS ports are supported for one code transmission. Therefore, if the transmission has more than 4 layers, 2 codewords should be used.

For example, when rank=5, two codewords are used for 2-layer and 3-layer transmissions. The DMRS ports can be in two antenna port groups, with one port group being associated with one codeword. Up to two bits can be used to indicate the PTRS-DMRS association. For example, for codebook-based transmissions, the Transmit Precoder Matrix Indicator (TPMI) can indicate the total rank and the association between the DMRS ports/port groups and the SRS ports/port groups. The total rank is five if the TPMI indicate the precoder as follows:

[1,0,1,0,1,0,1,0;
1,0,−1,0,1,0,−1,0;
0,1,0,1,0,1,0,1;
0,1,0,−1,0,1,0,−1;
0,1,0,1,0,−1,0,−1]’.

It can also be determined that the first two DMRS ports share the same SRS ports and associated with the same antenna port group.
1. In some implementations, a first antenna port group corresponds to 2-layer transmission and a second antenna port group corresponds to 3-layer transmission. If the first antenna port group corresponds to the codeword with the higher MCS value, 1 bit is needed to indicate the association of the PTRS port and the DMRS ports. If the second antenna port group corresponds to the codeword with the higher MCS value, 2 bits are needed to indicate the association between the PTRS port and the three DMRS ports if a single PTRS port is configured. In some implements, two PTRS ports are configured, and 1 bit is needed to indicate the association between each of the two PTRS ports and the three DMRS ports.
2. In some implementations, a first antenna port group corresponds to 1-layer transmission and a second antenna port group corresponds to 4-layer transmission. If the codeword with the higher MCS value corresponds to the first antenna port group comprising two DMRS ports, 2 PTRS ports are needed. In this case, the two DMRS ports can have a one-to-one mapping with the two PTRS ports, so 0 bit is needed to indicate the association of the PTRS port and the DMRS ports. If the codeword with the higher MCS value corresponds to the second antenna port group, 1 PTRS port is needed, and 1 bit is needed to indicate the association between the PTRS port and the two DMRS ports. In some implements, one PTRS port is configured, and 1 bit is needed to indicate the association between the PTRS ports and the DMRS ports.

As another example, when rank=6, two codewords are used for 3-layer and 3-layer transmissions. Up to two bits can be used to indicate the PTRS-DMRS association.
1. In some embodiments, a first antenna port group corresponds to 3-layer transmission and a second antenna port group corresponds to 3-layer transmission. If the first antenna port group is associated with one codeword with higher MCS, 2 bits can be used to indicate the association between the PTRS port and the three DMRS ports. Similarly, 2 bits can be used to indicate the association between the PTRS port and the three DMRS ports for the second antenna group associated with a codeword with higher MCS.
2. In some embodiments, a first antenna port group corresponds to 4-layer transmission and a second antenna port group corresponds to 2-layer transmission. If the codeword with the higher MCS value is associated with the first three DMRS ports, 1 PTRS port is needed. In this case, 2 bits can be used to indicate the association between the PTRS port and the DMRS ports. If the codeword with higher MCS is associated with the last 3 DMRS ports, 2 PTRS ports are needed, and 1 bit is needed.
3. In some embodiments, a first antenna port group corresponds to 2-layer transmission and a second antenna port group corresponds to 4-layer transmission. If the codeword with higher MCS is associated with the first 3 DMRS ports, 2 PTRS ports are needed. In this case, 1 bit can be used to indicate the association of the two PTRS ports and the three DMRS ports. If the codeword with higher MCS is associated with the last 3 DMRS ports, 1 PTRS port is needed and 2 bits are needed. In this case, the last 3 DMRS ports associated with the second antenna port group. If partial coherent is needed in one antenna port group, two PTRS ports are needed. One PTRS is shared by two DMRS ports, and the other PTRS port is associated with the other DMRS port with higher MCS. In such case, 1 bit is needed to indicate the association between the DMRS port and the PTRS port. When full coherent is supported in one antenna port group, or max 1 PTRS port is supported for one antenna port group, only 1 PTRS port is needed. One DMRS port of the 3 DMRS ports with higher MCS is indicated to be associated with the PTRS port, and 2 bits are needed to indicate the association between the DMRS and the PTRS.

Yet as another example, when rank=7, two codewords are used for 3-layer and 4-layer transmissions. Up to two bits can be used to indicate the PTRS-DMRS association.
1. In some embodiments, a first antenna port group corresponds to 3-layer transmission and a second antenna port group corresponds to 4-layer transmission. If the codeword with higher MCS is associated with the first antenna port group, 2 bits can be used to indicate the association of PTRS port and DMRS ports. Similarly, f the codeword with higher MCS is associated with the second antenna port group, 2 bits are needed to indicate the association of PTRS port and DMRS ports.
2. In some embodiments, a first antenna port group corresponds to 4-layer transmission and a second antenna port group corresponds to 3-layer transmission. If the code with higher MCS is associated with the first 3 DMRS ports, 2 bits can be used to indicate the association of PTRS port and DMRS ports. If the codeword with higher MCS is associated with the last 3 DMRS ports, and the 3 DMRS ports are associated with one antenna port group. If up to one 1 PTRS port is needed for one antenna port group, one DMRS port from the 3 DMRS ports with higher MCS is indicated with the PTRS port, and 2 bits are needed to indicate the association between the DMRS and the PTRS.

Yet as another example, when rank=8, two codewords are used for 4-layer and 4-layer transmissions. Up to two bits can be used to indicate the PTRS-DMRS association. In some embodiments, the PTRS port(s) are associated with DMRS with higher MCS of the codeword. One PTRS port is associated with one antenna port group while the other antenna port group is not associated to any of the PTRS ports.

In some embodiments, the DMRS ports are organized or configured into more than one port group, more than one PTRS port can be used. In some embodiments, two PTRS ports are associated with different antenna port groups or different codewords, then the actual number of PTRS ports are determined by the indicated MCS level of the associated codeword.

In some embodiments, the UE can report one or two MCS thresholds based on the UE capability. Alternatively, or in addition, the MCS threshold is configured by the base station in the PTRS configuration (e.g., via RRC signaling). If only one MCS threshold is reported or configured, the two PTRS ports are associated with the reported MCS threshold. The reported MCS threshold corresponds to the higher MCS, the lower MCS, or a combined MCS value of the two codewords. If the MCS of one codeword is smaller than the threshold, the related PTRS port is absent. If more than one PTRS ports are associated with one codeword, then the related PTRS ports are absent. If both MCS values of the two codewords are smaller than the threshold, the related two PTRS ports are absent. Alternatively, or in addition, if one of the indicated MCS is smaller than the threshold, all the PTRS ports are absent. If one of the indicated MCS is not smaller than the threshold, all the PTRS ports are present.

If two MCS thresholds are reported or configured for the two codewords, then the MCS of a codeword is compared to the respective threshold that corresponds to the same codeword. If the MCS is smaller than the threshold, the related PTRS port is absent. The actual PTRS port number is associated with the indicated MCS for each codeword.

In some embodiments, one antenna port group is associated with one codeword (e.g., rank 5 with DMRS ports for 2-layer and 3-layer transmission, rank 6 with DMRS ports for 3-layer and 3-layer transmissions, rank 7 with DMRS ports for 3-layer and 4-layer transmissions, rank 8 with DMRS ports for 4-layer and 4-layer transmissions). If more than 4 layers are indicated or configured, two codeword are supported. For rank 5, the first 2 layers and the other 3 layers are associated with the two codewords respectively. Similarly, for rank 6, the first 3 layers and the other 3 layers are associated with each codeword. For rank 7, 3 layers for the first CW and other 4 layer are associated with the two codewords respectively. For rank 8, the first 4 layers and the other 4 layers are associated with each codeword. Hence, in such cases, one antenna port group is associated with one codeword. Whether one PTRS port is absent or not is based on the indicated MCS for each codeword. When the indicated MCS values are different for the two codewords, the actual number of PTRS port(s) can be less than the configured maximum number of PTRS ports.

In some embodiments, multiple codewords are associated with one antenna port group (e.g., rank 7 with DMRS ports for 4-layer and 3-layer transmissions). For rank 7, the first 3 layers (DMRS ports) are associated with the first codeword, but 4 DMRS ports are associated with the first antenna port group. The PTRS ports can be associated with the DMRS ports with higher MCS value(s).

In some embodiments, the maximum rank is greater than 4, but the actual transmitted rank is no more than 4. Only one codeword is indicated and the PTRS ports can be associated with the codeword with higher MCS.

Table 3 illustrates an example of PTRS-DMRS association for uplink (UL) PTRS ports 0 and 1.

TABLE 3
PTRS-DMRS association for UL PTRS ports 0 and 1

| 1^{st} | | 2^{nd} | |
|---|---|---|---|
| bit | DMRS port | bit | DMRS port |
| 0 | 1^{st} DMRS port of the | 0 | 1^{st} DMRS port of the |
| | codeword with higher MCS | | codeword with higher MCS |
| | which shares PTRS port 0 | | which shares PTRS port 1 |
| 1 | 2^{nd} DMRS port of the | 1 | 2^{nd} DMRS port of the |
| | codeword with higher MCS | | codeword with higher MCS |
| | which shares PTRS port 0 | | which shares PTRS port 1 |

Table 4 illustrates another example of PTRS-DMRS association for UL PTRS ports 0 and 1.

TABLE 4
PTRS-DMRS association for UL PTRS ports 0 and 1

| Value of | | Value of | |
|---|---|---|---|
| the first | | subsequent | |
| 2 bits | DMRS port | 2 bits | DMRS port |
| 0 | 1^{st} scheduled DMRS | 0 | 1^{st} scheduled DMRS |
| | port of the codeword | | port of the codeword |
| | with higher MCS | | with higher MCS |
| | which shares PTRS | | which shares PTRS |
| | port 0 | | port 1 |
| 1 | 2^{nd} scheduled DMRS | 1 | 2^{nd} scheduled DMRS |
| | port of the codeword | | port of the codeword |
| | with higher MCS | | with higher MCS |
| | which shares PTRS | | which shares PTRS |
| | port 0 | | port 1 |
| 2 | 3^{rd} scheduled DMRS | 2 | 3^{rd} scheduled DMRS |
| | port of the codeword | | port of the codeword |
| | with higher MCS | | with higher MCS |
| | which shares PTRS | | which shares PTRS |
| | port 0 | | port 1 |
| 3 | 4^{th} scheduled DMRS | 3 | 4^{th} scheduled DMRS |
| | port of the codeword | | port of the codeword |
| | with higher MCS | | with higher MCS |
| | which shares PTRS | | which shares PTRS |
| | port 0 | | port 1 |

For eight or more DMRS ports, if 2 or 4 or 8 antenna port groups are configured or indicated, up to 2 PTRS ports can be configured. If the 2 PTRS ports are associated with respective antenna port group(s), then Table 1 and/or Table 2 can be used to determine the association between DRMS port(s) and PTRS port(s). If the actual PTRS port is one, Table 1 and/or Table 2 are still applicable. The PTRS port can be associated with one of the antenna port group or the PTRS port can be associated with the codeword with higher MCS.

For eight or more DMRS ports, if 4 or 8 antenna port groups are configured or indicated, up to 4 PTRS ports can be configured. The 2 or 4 PTRS ports are associated with respective antenna group(s). If the actual PTRS port is one, the PTRS port can be associated with one of the antenna port group or the PTRS port can be associated with the codeword with higher MCS.

Table 5 shows an example process for determining an association between the DMRS port(s)/port group(s) and the PTRS port(s) in accordance with one or more embodiments of the present technology.

TABLE 5
Example Determination Process

If maxRank > 4,

| | |
|---|---|
| ● | If number of PT-RS ports is configured as ‘1’ |

For partial-coherent, association between 1 PT-RS port and antenna port group

corresponding to the codeword with max MCS

| | |
|---|---|
| ● | Else if number of PT-RS ports is configured ‘>1’ |

RRC/pre-defined: Association between 1 PT-RS port and 1 antenna port group can

be determined using one of the options below:

```
  ● to-1 mapping for two antenna port groups;
  ● to-2 mapping for four antenna port groups;
  ● to-4 mapping for eight antenna port groups;
Number of actual PT-RS ports is determined according to number of DMRS
```

ports/actual rank, and/or MCS > a threshold;

| | |
|---|---|
| ◯ | If actual number PT-RS ports is 1 (e.g., QPSK) and 2 codewords and Rank>5, for |
| | partial-coherent, association between 1 PT-RS port and antenna port group |
| | corresponding to the codeword with max MCS |
| ◯ | If having MCS (e.g., for one codeword) <= a threshold, actual number of PT-RS |
| | ports is 1. |
| ◯ | ‘1 actual PT-RS’ (PTRS#0 or #1) is associated with ‘SRS/antenna port group’ or |
| | ‘DMRS port group’ (e.g., with higher MCS/additional codewords). |

### Embodiment 3: Configuration/Indication of the Associations

This embodiment describes the configuration or the indication of the association(s). The association between antenna port group(s) and PTRS port(s) can be pre-defined or RRC configured.

In some embodiments, the association(s) can be pre-defined as specified in one of the examples above. The pre-defined association can be based on the UE reporting. For example, UE can report the preferred association between antenna port group(s) and PTRS port(s). Based on the UE reporting, the base station or gNB can select one of the predefined associations.

In some embodiment, the UE can support one or more configurations. The UE can determine the association based one or more of pre-defined rules. For example, if the number of antenna port groups is configured as 4, Configuration 1 indicates that antenna port group 0,1 share PTRS 0, and antenna port group 2,3 share PTRS port 1. Configuration 2 indicates that antenna port group 0,2 share PTRS port 0, and antenna port group 1,3 share PTRS port 1. As another example, if the antenna port group is configured as 8, Configuration 1 indicates that antenna port group 0,1,2,3 share PTRS port 0 and antenna port group 4,5,6,7 share PTRS port 1. Configuration 2 indicates that antenna port group 0,2,4, 6 share PTRS port 0 and antenna port group 1,3,5,7 share PTRS port 1. Additional configurations can be provided to indicate different associations of the port groups and the PTRS ports.

In some embodiments, the association can be configured or indicated by the base station via signaling message such as RRC, Medium Access Control (MAC) Control Element (CE), or Downlink Control Information (DCI). For example, using RRC configuration, the number of antenna port group(s) and/or codebook/non codebook or coherent type can be configured in the Physical Uplink Shared (PUSCH) configuration. In some embodiments, the SRS port related information is configured in the SRS Config of the RRC Information Element (IE). More specifically, for non-codebook-based transmissions, the association of PTRS port and SRS ports/port groups can be configured in the SRS configuration. For codebook-based transmission, the association of SRS ports/port groups can be configured in the SRS configuration or PUSCH configuration. In the SRS configuration, the association of PTRS and SRS port is configured similar to the non-codebook-based transmission; the configuration can indicate which SRS ports/antenna port group(s) share one PTRS. For PUSCH configuration, if full coherent transmission is configured (e.g., number of antenna port group=1), the PTRS is shared by all SRS ports, and there is no need to configure the association of SRS port/antenna port group and PTRS port. For partial coherent transmissions (e.g., two types of partial coherent associated with antenna port group=2 or 4), which antenna port group(s)/SRS ports share PTRS port0 can be configured when partial coherent is configured.

The SRS resource or port is indicated by SRS Resource Indication (SRI) field in DCI for both codebook-based and non-codebook-based uplink transmissions. In codebook-based transmissions, the related precoder is indicated by Transmit Precoder Matrix Indicator (TPMI) field for codebook-based uplink transmissions. If two SRI fields or TPMI field(s) are indicated in DCI when the max rank is configured more than 4, each field is associated with one PTRS port. The related SRS ports/antenna port groups associated with one SRI/TPMI field share one PTRS port.

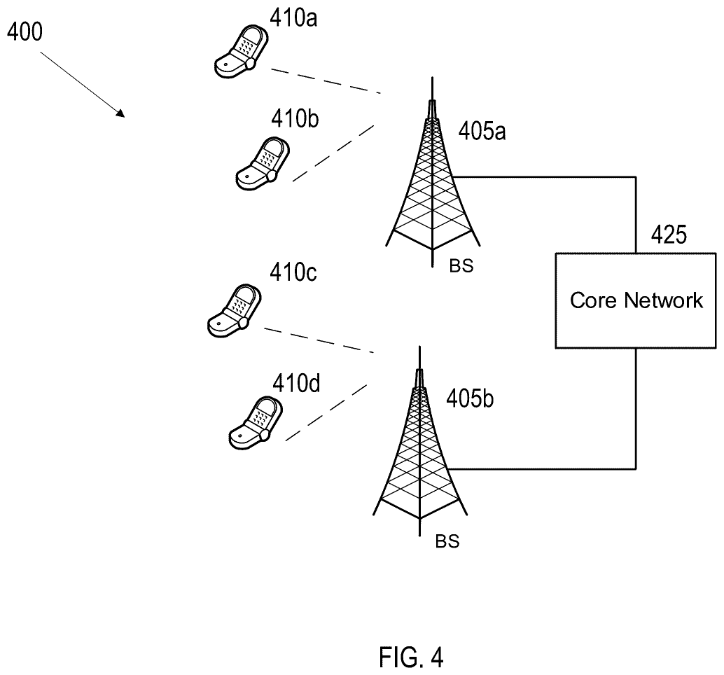

FIG. 4 shows an example of a wireless communication system 400 where techniques in accordance with one or more embodiments of the present technology can be applied. A wireless communication system 400 can include one or more base stations (BSs) 405a, 405b, one or more wireless devices (or UEs) 410a, 410b, 410c, 410d, and a core network 425. A base station 405a, 405b can provide wireless service to user devices 410a, 410b, 410c and 410d in one or more wireless sectors. In some implementations, a base station 405a, 405b includes directional antennas to produce two or more directional beams to provide wireless coverage in different sectors. The core network 425 can communicate with one or more base stations 405a, 405b. The core network 425 provides connectivity with other wireless communication systems and wired communication systems. The core network may include one or more service subscription databases to store information related to the subscribed user devices 410a, 410b, 410c, and 410d. A first base station 405a can provide wireless service based on a first radio access technology, whereas a second base station 405b can provide wireless service based on a second radio access technology. The base stations 405a and 405b may be co-located or may be separately installed in the field according to the deployment scenario. The user devices 410a, 410b, 410c, and 410d can support multiple different radio access technologies. The techniques and embodiments described in the present document may be implemented by the base stations of wireless devices described in the present document.

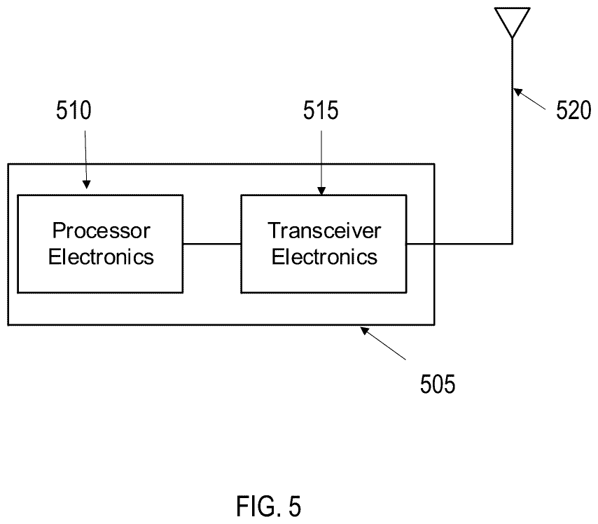

FIG. 5 is a block diagram representation of a portion of a radio station in accordance with one or more embodiments of the present technology can be applied. A radio station 505 such as a network node, a base station, or a wireless device (or a user device, UE) can include processor electronics 510 such as a microprocessor that implements one or more of the wireless techniques presented in this document. The radio station 505 can include transceiver electronics 515 to send and/or receive wireless signals over one or more communication interfaces such as antenna 520. The radio station 505 can include other communication interfaces for transmitting and receiving data. Radio station 505 can include one or more memories (not explicitly shown) configured to store information such as data and/or instructions. In some implementations, the processor electronics 510 can include at least a portion of the transceiver electronics 515. In some embodiments, at least some of the disclosed techniques, modules or functions are implemented using the radio station 505. In some embodiments, the radio station 505 may be configured to perform the methods described herein.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method for wireless communication, comprising:
determining, by a terminal device for an uplink transmission, one or more phase-tracking reference signal (PTRS) ports that are associated with one or more antenna ports in a number of antenna port groups, wherein one or more antenna ports in an antenna port group share a same PTRS port and wherein the one or more antenna ports comprise Demodulation Reference Signal (DMRS) ports; and
performing, by the terminal device, the uplink transmission to a base station based on the one or more PTRS ports.

2. The method of claim 1, wherein the one or more antenna ports are in one antenna port group corresponding to one PTRS port.

3. The method of claim 1, wherein the antenna port groups comprise:
a first group of ports {0, 4, 1, 5} and a second group of ports {2, 6, 3, 7}.

4. The method of claim 1, wherein the antenna port groups comprise:
a first group of ports {0, 4}, a second group of ports {1, 5}, a third group of ports {2, 6}, and a fourth group of ports {3, 7}.

5. The method of claim 1, wherein a modulation and coding scheme (MCS) configured or indicated by the base station is associated with each of the one or more PTRS ports.

6. The method of claim 5, wherein a PTRS port is associated with an antenna port group corresponding to a higher MCS than other one or more antenna port groups.

7. The method of claim 5, wherein one or more PTRS ports are absent in response to a corresponding codeword having MCS value lower than a single MCS threshold, wherein the single MCS threshold is reported by the terminal device or configured by based station.

8. The method of claim 5, further including at least one of:
if all MCS values of are smaller than a threshold, then all PTRS ports are absent,
if at least one MCS value is smaller than the threshold, then all PTRS ports are absent; or
if at least one MCS value is not smaller than the threshold, then all PTRS ports are present.

9. The method of claim 1, wherein, a single modulation and coding scheme (MCS) is indicated for a codeword associated with PTRS, and wherein two PTRS ports are determined according to the indicated MCS of the codewords.

10. A method for wireless communication, comprising:
configuring, by a base station, one or more phase-tracking reference signal (PTRS) ports that are associated with one or more antenna port in a number of antenna port groups, wherein one or more antenna ports in an antenna port group share a same PTRS port and wherein the one or more antenna ports comprise Demodulation Reference Signal (DMRS) ports; and
receiving, by the base station, an uplink transmission with a terminal device based on the one or more PTRS ports.

11. The method of claim 10, wherein the antenna port groups comprise:
a first group of ports {0, 4, 1, 5} and a second group of ports {2, 6, 3, 7}; or
a first group of ports {0, 4}, a second group of ports {1, 5}, a third group of ports {2, 6}, and a fourth group of ports {3, 7}.

12. The method of claim 10, wherein a modulation and coding scheme (MCS) configured or indicated by the base station is associated with the one or more PTRS ports.

13. The method of claim 12, wherein a PTRS port is associated with an antenna port group corresponding to a higher modulation and coding scheme (MCS) than other one or more antenna port groups.

14. The method of claim 13, wherein one or more PTRS ports are absent in response to a corresponding codeword having MCS value lower than a single MCS threshold, wherein the single MCS threshold is reported by the terminal device or configured by based station.

15. The method of claim 12, wherein all the one or more PTRS ports are assumed to be present responsive to the MCS not being smaller than a threshold.

16. The method of claim 10, wherein, a single modulation and coding scheme is indicated for a codeword associated with PTRS, and wherein two PTRS ports are determined according to the indicated modulation and coding scheme of the codewords.

17. A terminal device, comprising at least one processor configured to cause the terminal device to implement a method, comprising:
determining, by the terminal device for an uplink transmission, one or more phase-tracking reference signal (PTRS) ports that are associated with one or more antenna ports in a number of antenna port groups, wherein one or more antenna ports in an antenna port group share a same PTRS port and wherein the one or more antenna ports comprise Demodulation Reference Signal (DMRS) ports; and
performing, by the terminal device, the uplink transmission to a base station based on the one or more PTRS ports.

18. The communication apparatus of claim 17, wherein the one or more antenna ports are in one antenna port group corresponding to one PTRS port.

19. The communication apparatus of claim 17, wherein the antenna port groups comprise:
a first group of ports {0, 4, 1, 5} and a second group of ports {2, 6, 3, 7}; or
a first group of ports {0, 4}. a second group of ports {1, 5}. a third group of ports {2, 6}, and a fourth group of ports {3, 7}.

20. The communication apparatus of claim 17, wherein a modulation and coding scheme (MCS) configured or indicated by the base station is associated with the one or more PTRS ports.
